(19) United States
(12) Patent Application Publication
(10) Pub. No.: US 2016/0236487 A1
(43) Pub. Date: Aug. 18, 2016

(54) PRINTING MACHINE FOR PLATES

(71) Applicant: ENGICO S.R.L., LISSONE (Monza Brianza) (IT)

(72) Inventor: Rinaldo BENZONI, PADERNO DUGNANO (Milano) (IT)

(73) Assignee: ENGICO S.r.L., LISSONE (Monza Brianza), OT (IT)

(21) Appl. No.: 15/025,013

(22) PCT Filed: Sep. 17, 2014
(86) PCT No.: PCT/IB2014/064590

§ 371 Date: Mar. 25, 2016

(30) Foreign Application Priority Data
Sep. 25, 2013 (EP) 13186023.1

(51) Int. Cl. B41J 11/00

(52) U.S. Cl. CPC B41J 11/007

(57) ABSTRACT

Provided is a printing machine including printing means configured for printing on at least a portion of the surface of a board arranged along a printing area. The printing machine also includes a conveyor means configured to convey the board along a feed path and to supply and free the printing area. The conveyor means may include at least one conveyor belt which occupies at least a portion of the printing area, having a breathable surface layer and suction means configured to draw in air through the surface layer so as to define a suction surface configured to hold the board in place and arranged in proximity to the printing surface. The conveyer means may also include a transfer means configured to move the suction surface along the feed path with respect to the printing area.

The present invention relates to a printing machine for plates or sheets, in particular for cardboard, of the type as recited in the preamble of the first claim.

Printing machines for various types of board or sheets, such as cardboard, in particular compact, corrugated or honeycomb cardboard, are known in the prior art.

In particular, digital printing has recently been increasingly used for this purpose.

For example, corrugated cardboard can be printed using two different methods.

A first method consists of printing one sheet, called the liner sheet, which, once printed, is glued to the remaining sheets to form the corrugated cardboard.

This method achieves good quality printing. However, the liner sheet may be damaged during the process to make the corrugated cardboard. Moreover, with this process, the printing step is always followed by another process and it is impossible to manufacture stocks of corrugated cardboard to be printed upon request. This undoes some of the benefits of flexibility and speed which characterize digital printing.

A second method consists of printing the assembled corrugated cardboard.

This process has considerable advantages in terms of flexibility and speed of processing, especially when digital printing is used.

Moreover, printing is not followed by another process that could undermine the quality of printing.

However, the prior art mentioned above has several significant drawbacks.

In particular, the cardboard is not always perfectly flat, as it should be to achieve good printing.

Moreover, like other composite boards such as polymer board or board made of other materials, cardboard has a high bending strength and low mass, and so does not lie flat under its own weight or stay flat when laid down.

The above drawbacks negatively affect the quality of printing on cardboard and similar materials.

In this situation the technical purpose of the present invention is to develop a printing machine for plates, and a printing process, able to substantially overcome the inconveniences mentioned above.

Within the scope of said technical purpose an important aim of the invention is to provide a printing machine for stiff or flexible board which achieves high quality printing.

Another important aim of the invention is to provide a printing machine for plates which permits high speed and flexibility of printing.

A further aim of the invention is to provide a printing machine for plates which is straightforward and economical.

The technical purpose and specified aims are achieved by a printing machine for plates as claimed in the appended claim 1.

Preferred embodiments are described in the dependent claims.

The characteristics and advantages of the invention are clearly evident from the following detailed description of a preferred embodiment thereof, with reference to the accompanying drawings, in which:

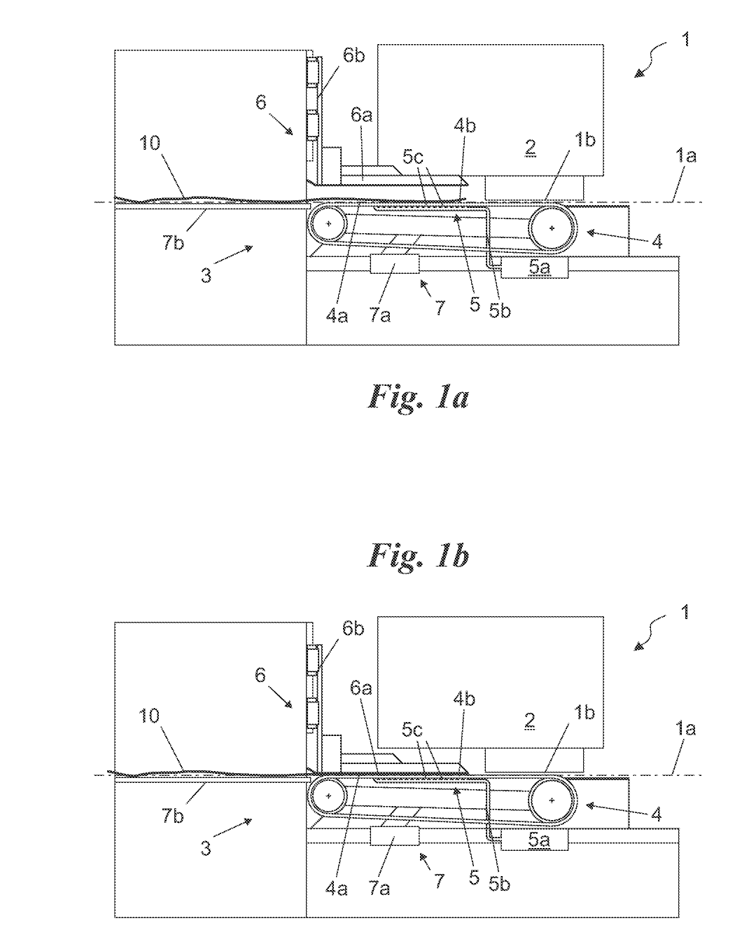

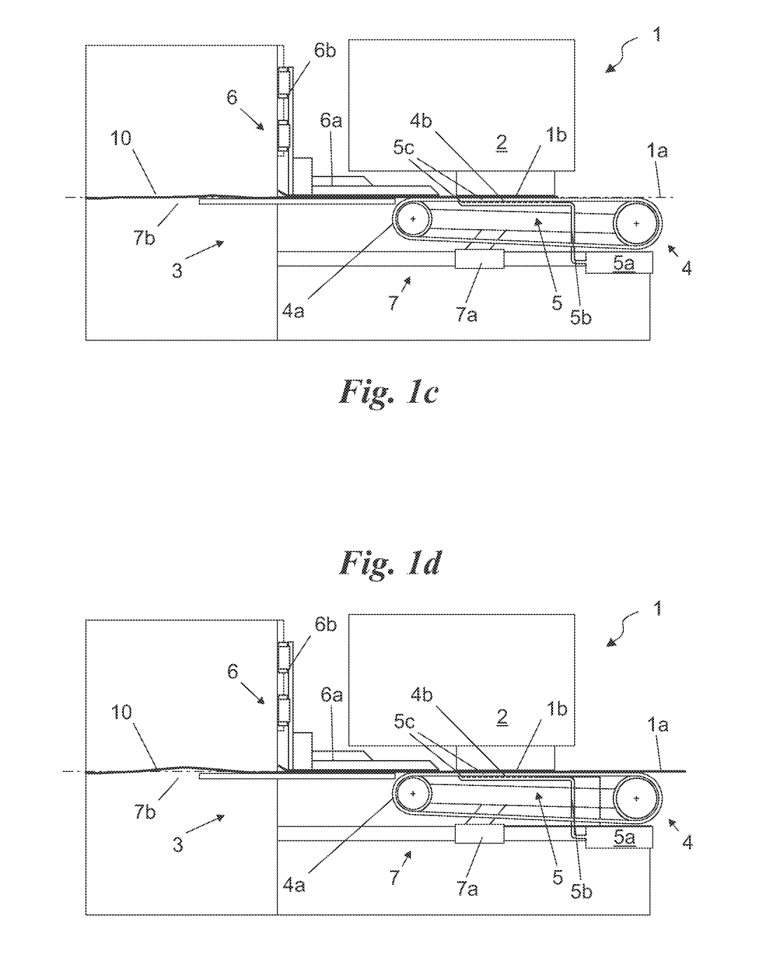

FIG. 1a shows the printing machine according to the invention in a first position;

FIG. 1b shows the printing machine according to the invention in a second position;

FIG. 1c shows the printing machine according to the invention in a third position;

FIG. 1d shows the printing machine according to the invention in a fourth position;

FIG. 1e shows the printing machine according to the invention in a fifth position;

FIG. 1f shows the printing machine according to the invention in a sixth position; and

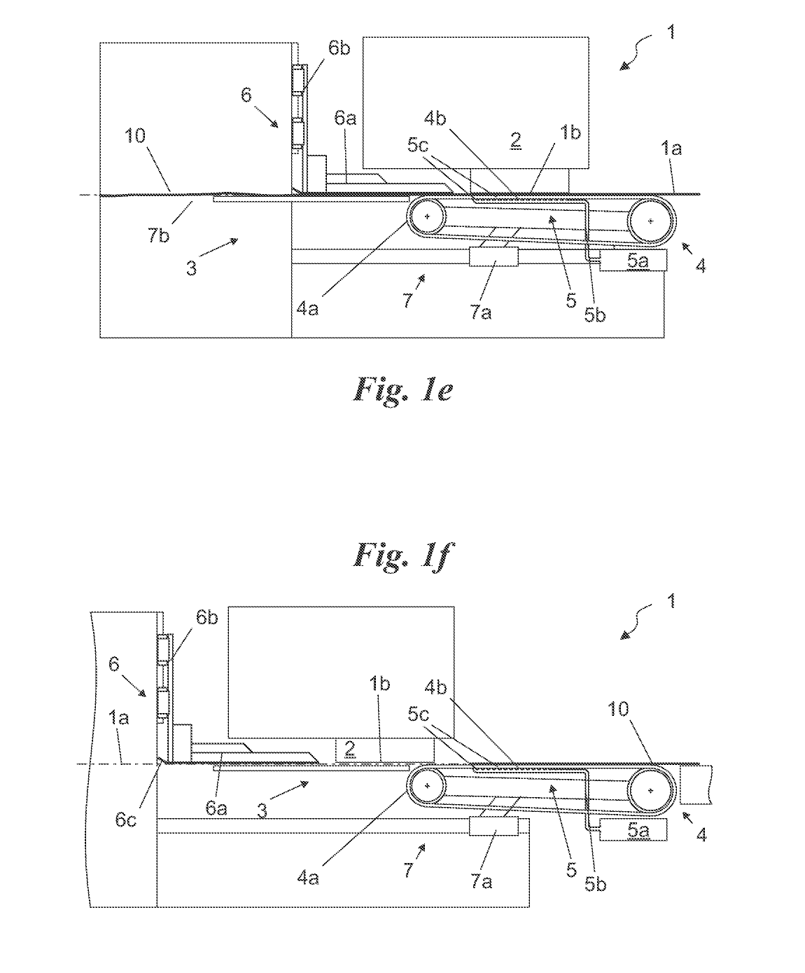

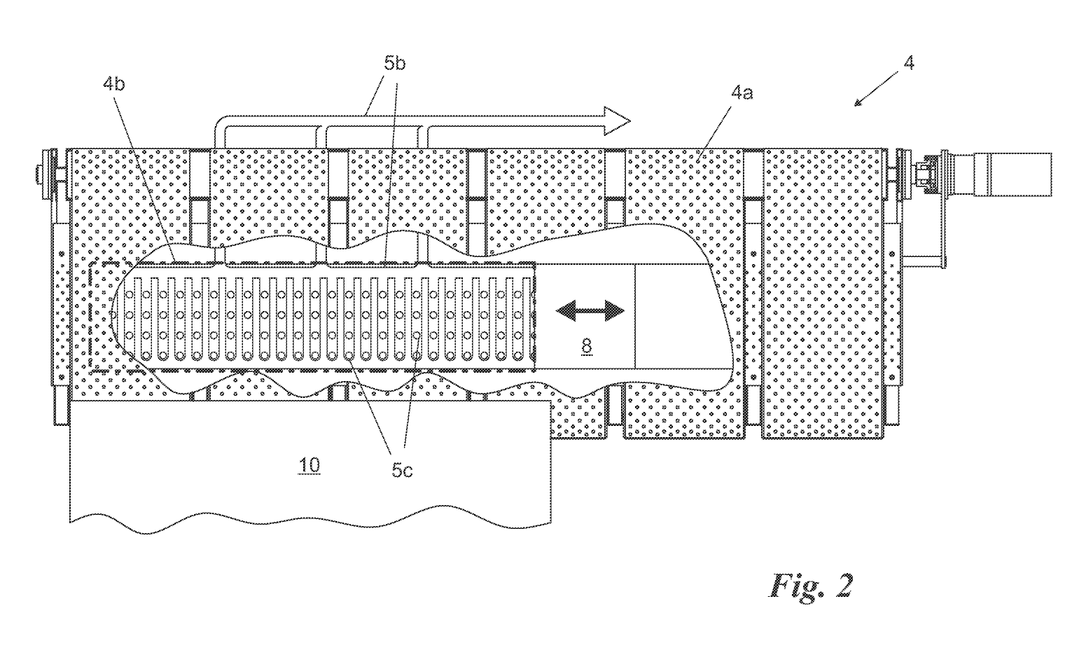

FIG. 2 shows a portion of the machine in a partial section view.

With reference to said drawings, reference numeral 1 globally denotes the printing machine according to the invention.

It is suitable for printing on board 10, in particular lightweight and sufficiently stiff board, more in detail the machine is suitable for printing on cardboard, more in particular on compact, corrugated or honeycomb cardboard. Other suitable materials include other types of cardboard and paper, polymer board, such as correx or other types, composite board, for example with a polymer core and paper liner sheets, rigid board, and so on.

The printing machine 1 comprises printing means 2, suitable to print at least a portion of a main surface of extension of the board 10, and conveyor means 3 suitable to convey the board 10 along a feed path 1a and to supply and free the printing means 2.

In particular the printing means 2 consist of a digital printer, in particular of the inkjet type. It may be of the scanning mode type, i.e. with printheads that move perpendicularly to the feed path 1a, or of the single pass type, i.e. with fixed printheads aligned perpendicularly with respect to the feed path 1a.

In either case, the printing means 2 define a printing area 1b, that is to say an area, preferably flat, in which the board is printed, and which is thus arranged along the feed path 1a. In particular the width of the printing area 1b is appropriately equal to the maximum width of the board 10 that can be processed by the machine and its length along the feed path 1a is variable.

The conveyor means 3 are thus suitable to supply and free said printing area 1b to permit the positioning of the portion of the board 10 to be printed inside said printing area 1b. As is known, digital printers print one portion of the board 10 at a time, and feeding may be performed at intervals, in particular for scanning mode printers, or continuously, in particular for single pass printers.

The conveyor means 3 comprise at least one conveyor belt 4 which occupies at least part of the printing area 1b, and has a breathable surface layer 4a. It preferably consists of a continuous conveyor belt or other type of conveyor. The surface layer 4a is breathable owing to the intrinsic properties of the material, for example fabric, or owing to perforations, as illustrated in FIG. 2.

The conveyor means 3 also comprise, preferably connected to the conveyor belt 4, suction means 5, suitable to draw in air through the surface layer 4a thus defining a suction surface 4b.

The suction surface 4b is appropriately above the suction means 5 and is suitable to hold the board 10 in a flat position. It is also arranged in proximity to or in correspondence with said printing surface 1b.

The dimensions of the suction surface 4b are such to permit said surface to hold the board 10 flat without any deformation or bending of the board 10 that would cause the latter to be separated from the suction surface 4b. In particular, for the cardboard said length may be comprised between 30 cm and 80 cm.

The suction means 5 preferably comprise a vacuum pump 5a connected to ducts 5b ending in holes 5c or apertures in correspondence with the breathable surface layer 4a (FIG. 2).

Moreover, the suction means 5 appropriately comprise partialization means 8 of the suction surface 4b, suitable to alter the size or the position of the suction surface 4b. They are preferably suitable to alter the size of the suction surface 4b in a direction perpendicular to the feed path 1a and parallel to the suction plane 4b, so that the width of the suction surface 4b is identical to the width of the board 10, in the direction shown.

The partialization means 8 may act by means of a mobile, non-breathable element which obstructs the holes 5c. They may also act in a direction parallel to the feed path 1a and may serve to move the suction surface, as described in detail below.

The conveyor means 3 also appropriately comprise alignment means 6 or levelling means of the board 10 on the suction surface 4b, arranged in correspondence with the opposite surface of the board 10 with respect to the surface layer 4a and suitable to make the board 10 adhere to the suction surface 4b, substantially at least along the entire area of the suction surface 4b.

The alignment or levelling means 6 are thus suitable to eliminate any irregularities in the board 3 with respect to the surface layer 4a, such as raised areas, various deformations, bending, bulging. Moreover, the alignment means only need to act initially for a first portion of the board 10, after which the suction surface 4b will have enough force to hold the board in the correct position.

In particular the alignment means 6 comprise a plate 6a which is substantially a counter-profile of the suction surface 4b and transfer means 6b for moving the plate 6a, such as a sliding block with actuators, suitable to move the latter so as to guarantee the adhesion of the board 10 to the suction surface. In particular, the plate 6a moves vertically and moves downwards to press on the board 10. In detail, it acts when the first part of the board 10 is placed on the suction surface 4b, as explained below.

The plate 6a may also comprise sliding means such as in particular rolls, ball-bearings, rollers, wheels or slides suitable to permit the most badly deformed parts of the board 10 to slide, without being damaged, when the board 10 slides beneath said plate 6a. The plate 6a is also preferably suitable to facilitate the maintenance of the board 10 in the flat position, after the action exerted by the transfer means 6b, as described more fully below.

Moreover the printing machine 1 comprises transfer means 7 suitable to move the suction surface 4b with respect to the printing area 1b, along the feed path 1a.

Said movement has the important advantage of always maintaining the board 10 in contact with the whole of the suction surface 4b, so that even in the initial and final stages of printing on the board 10 the latter is always completely flat.

The maximum transfer stroke is preferably at least equal to the length, along the feed path 1a, of the suction surface 4b.

This is achieved by moving the suction area 4b along the feed path 1a, or by moving the printing means 2, in particular the printheads, or even by moving both.

Preferably, the transfer means 7 comprise a carriage 7a including said conveyor belt 4 and at least part of said suction means, as illustrated in FIGS. 1a-1f. The carriage 7a is thus suitable to translate in the direction of the feed path 1a, in particular in the first and/or final stage of the printing process, so as to also permit printing on the initial and final portion of the board 10, advantageously without ever freeing the suction surface 4b, even partially, and thus without any loss of the vacuum. The carriage 7a may also comprise other similar sliding planes 7b, suitable to permit the transfer of the board 10.

Alternatively, the transfer means 7 may comprise means for moving the suction means 5 only, which thus define a movement of the suction surface 4b, the portion of conveyor belt 4 of which varies continuously. The movement of the suction surface 4b may be achieved through partialization means 8 which act parallel to the feed path 1a and are suitable to move the suction surface 4b.

The functioning of the printing machine 1 described above in a structural sense, is as follows. It defines an innovative printing process for plates 10 and other similar materials.

The process consists of first placing the board 10 on the printing machine 1.

The printing machine 1 may be installed downstream or upstream of other processing stations of the board 10, in particular of compact, corrugated, honeycomb or similar types of board.

First of all the adjustments to the machine 1 are performed, such as adjustments to the partialization means 8 which are arranged so that the width of the suction surface 4b substantially coincides with the width of the board 10. The length of the board 10 is instead usually greater, even by up to several metres.

The board 10 travels along the feed path 1 and reaches the conveyor belt 4 arranged on the carriage 7a. The board 10 is then placed on the suction surface 4b so as to come into contact therewith, while the plate 6a, which is part of the alignment means 6, is in a raised position (FIG. 1a).

At this point the process consists of the step of aligning the board 10 with respect to the suction surface 4b, by acting in correspondence with the opposite surface of the board 10 with respect to the surface layer 4a, so as to make the board 10 adhere to the suction surface 4b, to cover the whole area of the suction surface 4b.

In detail, the alignment means 6 are activated so that the plate 6a at least moves the board 10 towards the suction surface 4b so that the surface of the board 10 and the suction surface 4b are perfectly overlapping and contiguous (FIG. 1b). In particular, the board 10 stops at approx. 1 cm, or at a distance that has been appropriately selected depending on the material of which the board 10 is made, so that the vacuum created on the suction surface 4b pulls on the board 10 so as to align and flatten it.

In this situation, it is extremely advantageous that substantially the whole of the suction surface 4b is always covered by the board 10, so that there are no suction areas which are not covered by the board 10. Such areas could indeed cause a notable loss of suction force.

Next the plate 6a is raised slightly, for example by about 1 cm, so as to continue to partially align the board 10 (FIG. 1c), in particular by means of the sliding means described. Moreover the suction surface 4b is moved with respect to said printing area 1b along the feed path 1a. Said movement may be performed in the initial phase only, in the final phase only, or in both, as in the preferred embodiment.

In particular, the carriage 7a initially moves the suction surface 4b underneath the printing area 1b (FIG. 1c).

The printing means 2 print the first part of the board 10 and, once it has been printed, the board 10 is transferred further along the feed path 1a so that the area immediately after it can be printed.

During these operations there is no need for the plate 6a to repeat the initial movement to continuously align the board 10 along the suction surface 4b. The force of the suction surface 4b is in fact sufficient to hold the board 10 in the correct position and aligned.

However, in this step the plate 6a helps to align the board 10 (FIG. 1d).

Lastly, the final portion of the board 10 reaches the suction surface 4b (FIG. 1e).

In this position the conveyor belt 4 stops so that the board 10 remains on the suction surface 4a without ever leaving the suction surface clear. Moreover, in this position, the transfer means 7 and in particular the carriage 7a may be used to end printing (FIG. 1f).

The entire movement of the board 10 is advantageously performed by means of the conveyor belt 4 and the transfer means 7, with the board 10 never leaving the suction surface 4b free, so as to always maintain the two in close contact and avoid any loss of the vacuum.

After printing, the transfer means can convey the board 10 to subsequent workstations or storage areas.

The invention achieves some important advantages.

With the printing machine 1, the board 10 is always perfectly flat 10 or in any case adheres to the suction surface 4b, regardless of its shape.

Said advantage is due in particular to the presence of the alignment means 6, the suction surface 4a and the fact that the board 10 adheres to the suction surface 4b along the entire area of said surface.

Moreover, owing to the presence of the transfer means 7, printing can even be performed on the initial and end portions of the board 10. This advantage is fundamental for full-bleed printing without borders.

Consequently, with the printing machine 1 printing of a high quality is achieved because the board is always flat, and the process is fast and flexible thanks to the use of digital printing means.

The printing machine 1 is also straightforward and economical.

Modifications and variations may be made to the invention described herein without departing from the scope of the inventive concept as expressed in the independent and dependent claims.

All the elements as described herein may be replaced with equivalent elements and the scope of the invention as claimed in the independent and dependent claims includes all other materials, shapes and dimensions.

1. A printing machine, for plates comprising:
printing means, configured to print at least a portion of a surface of a board arranged along a printing area,
conveyor means configured to convey said board along a feed path and to supply and free said printing area, said conveyor means comprising:
at least one conveyor belt which occupies at least a portion of said printing area, having a breathable surface layer and suction means configured to draw in air through said surface layer so as to define a suction surface configured to hold said board and arranged in proximity to said printing surface, and
transfer means configured to transfer said suction surface along said feed path with respect to said printing area.

2. The printing machine as claimed in claim 1, comprising alignment means for aligning said board with said suction surface arranged in correspondence with the opposite surface of said board with respect to said surface layer, configured to make said board adhere to said suction surface, substantially at least along the entire area of said suction surface.

3. The printing machine as claimed in claim 2, wherein said alignment means comprise a plate which is substantially a counter-profile of the suction surface and transfer means of said plate configured to move said plate so that it moves said board towards said suction surface.

4. The printing machine as claimed in claim 1 wherein said plate comprises sliding means configured to permit the sliding, without damage, of the most deformed portions of said board when the latter slides beneath said plate.

5. The printing machine as claimed in claim 1 wherein said transfer means comprise a carriage comprising said conveyor belt and at least part of said suction means.

6. The printing machine as claimed in claim 1 comprising partialization means of said suction surface configured to modify the size or the position of said suction surface.

7. A process for printing with the printing machine as claimed in claim 1, comprising:
placing said board in correspondence with said suction surface, wherein said placing comprises
aligning said board with respect to said suction surface so that substantially the whole of said suction surface is covered by said board, and
conveying said board along said feed path, by means of said conveyor belt and said transfer means, so that said board never leaves said suction surface free, so as to always maintain the two in close contact with no loss of the vacuum, printing on said board using said printing means.

8. The process as claimed in claim 7, comprising a step of moving said suction surface with respect to said printing area along said feed path which is performed at least in a period prior to or after said printing.

9. The process as claimed in claim 8, wherein aligning said board with respect to said suction surface is at least partially achieved by means of a plate which is substantially a counter-profile of the suction surface and transfer means suitable configured to move said plate so that it moves said board towards said suction surface and wherein said movement of said plate is performed exclusively when the first portion of said board is placed on top of said suction surface.

10. The process as claimed in claim 9, wherein after aligning said board with respect to said suction surface, said plate is raised slightly so that it can continue to partially align said board.
